(19) United States
(12) Patent Application Publication
(10) Pub. No.: US 2026/0227766 A1
(43) Pub. Date: Aug. 6, 2026

(54) METHOD AND SYSTEM FOR ESTABLISHING A COMMUNICATION LINK BETWEEN AN OPERATING UNIT AND A FIELD DEVICE FROM AUTOMATION ENGINEERING

(71) Applicant: Endress+Hauser Process Solutions AG, Reinach (CH)

(72) Inventors: Stephen Farey, Basel (CH); Emilio Schiavi, Oberwil (CH); Kai Weber, Weil am Rhein (DE); Daniel Lorenz, Birsfelden (CH); Werner Luber, Allschwil (CH)

(21) Appl. No.: 19/154,924

(22) PCT Filed: Feb. 14, 2024
(86) PCT No.: PCT/EP2024/053755

§ 371 Date: Aug. 8, 2025

(30) Foreign Application Priority Data
Feb. 16, 2023 (DE) 10 2023 103 919.9

(51) Int. Cl. G05B 19/418; H04W 4/80

(52) U.S. Cl. CPC G05B 19/4185; H04W 4/80

(57) ABSTRACT

A method for establishing a communication link between an operating unit and a field device from automation engineering, wherein a frame application and a Bluetooth server are executed on the operating unit, comprises connecting the operating unit to a Bluetooth gateway via a radio link via the Bluetooth server using a Bluetooth protocol, wherein the Bluetooth gateway is connected to the field device via a communication network; establishing a tunnel between the frame application and the Bluetooth gateway; sending information about the field device from the Bluetooth gateway to the frame application via the radio link; and instantiating a device driver for the field device and a communication driver based on the information about the field device. The device driver and communication driver create commands and/or queries to the field device in a format that complies with the communication protocol.

The invention relates to a method for establishing a communication link between an operating unit and a field device from automation engineering. The invention further relates to a system configured to carry out the method according to the invention.

Field devices that are used in industrial installations are already known from the prior art. Field devices are often used in process automation technology, as well as in manufacturing automation technology. In principle, all devices which are process-oriented and which supply or process process-relevant information are referred to as field devices. Field devices are thus used for detecting and/or influencing process variables. Measuring devices, or sensors, are used for detecting process variables. They are used, for example, for pressure and temperature measurement, conductivity measurement, flow measurement, pH measurement, fill level measurement etc., and detect the corresponding process variables of pressure, temperature, conductivity, pH value, fill level, flow, etc. Actuators are used for influencing process variables. These actuators are, for example, pumps or valves that can influence the flow of a fluid in a pipe or the fill level in a tank. In addition to the aforementioned measuring devices and actuators, field devices are also understood to include remote I/Os, radio adapters, or, generally, devices that are arranged at the field level.

A multitude of such field devices is produced and marketed by the Endress+Hauser group.

In modern industrial plants, field devices are usually connected to superordinate units via communications networks such as fieldbuses (Profibus®, Foundation® Fieldbus, HART®, etc.). Usually, the superordinate units are control systems (DCS) or control units, such as an SPC (stored program control). The superordinate units are used for, among other things, process control, process visualization, and process monitoring, as well as commissioning of the field devices. The measured values recorded by the field devices, especially by sensors, are transmitted via the respective bus system to a (or in some cases a plurality of) superordinate unit(s). In addition, data transmission from the superordinate unit via the bus system to the field devices is also required, especially for configuration and parameterization of field devices and for controlling actuators.

The integration of field devices into object-based configuration or management systems is effected via device descriptions, which ensure that the higher-level units can recognize and interpret the data provided by the field devices. The relevant device manufacturer provides the device descriptions for each field device type or for each field device type in different applications. In order for the field devices to be integrated into different fieldbus systems, it is also important to note that different device descriptions must be created for the different fieldbus systems. For example, there are HART, Fieldbus Foundation and Profibus device descriptions.

In order to create a uniform description for field devices, the Fieldbus Foundation (FF), the HART Communication Foundation (HCF) and the Profibus Nutzerorganisation (Profibus User Organization, PNO) have created a uniform electronic device description (EDD), which is defined in the IEC 61804-2 standard.

For a full scope of operation of the field devices, special device descriptions, known as DTMs (device type managers), which correspond to the FDT (field device tool) specifications, are available.

The FDT specification, which is considered an industry standard, was developed by the PNO in cooperation with the ZVEI (German Electrical and Electronic Manufacturers' Association). The current FDT specification is available from the ZVEI, the PNO or the FDT Group.

Many field device manufacturers already supply the corresponding DTMs with their field devices. The DTMs comprise all device-specific data, functions and operating rules, such as the device structure, available communication options and the graphical user interface, i.e. the GUI, for a specific field device or for a specific field device family.

As a runtime environment, the DTMs require a frame application, here the FDT frame. The frame application and the corresponding DTMs allow very convenient access to field devices, e.g. device parameters, measured values, diagnostic information, status information, etc., as well as the calling of special functions that are available to individual DTMs. The frame application and DTMs together form a subcomponent-based management or configuration system for field devices. In order for DTMs from different manufacturers to function correctly in the frame application, the interfaces to the frame application and to the other DTMs must be clearly defined. This interface definition is known by the abbreviation FDT. FDT technology standardizes the communications interface between the field devices and the higher-level unit. What is special about this technology is that it works independently of the communication protocol used and of the software environment of not only the field device but also of the higher-level system. FDT makes it possible to address any field device via any higher-level system with any communication protocol. A well-known FDT frame is, for example, “FieldCare,” which is marketed by the Endress+Hauser Group.

Like the device drivers, a communication driver (CommDTM) is integrated into the frame application. It ensures that the operating commands or requests to a field device created by a device driver are converted into the corresponding communication protocol of the fieldbus network.

Mobile operating units can also be used to operate field devices that have implemented an FDT frame application. For example, there are operating units that are connected to the fieldbus network. However, it is also possible to operate the operating unit via a second data channel (the first data channel is the fieldbus network). For example, the operating unit is connected to the field device via a wired access via a special service interface of the field device. The field devices marketed by the applicant, for example, use the proprietary CDI (“common data interface”) standard for this purpose.

However, the operating unit can also communicate with the field devices via a wireless communications connection, in particular based on a Bluetooth standard. The applicant produces and sells devices which, as so-called Bluetooth gateways, allow the operating units to be coupled to the field devices. The field device is connected to a Bluetooth gateway via wires, in particular using the HART or CDI communication standards.

However, the wireless configuration of the field devices can only be done via TCP/IP using the standard FDT/DTM technology, provided a communication DTM is available. Currently, there is no communication driver that can communicate with Bluetooth gateways by means of encrypted Bluetooth communication.

This makes it impossible to configure field devices connected to the Bluetooth gateway via HART or CDI by means of an operating unit having an FDT frame application.

Proceeding from this problem, the invention is based on the object of making it possible to operate a field device using FDT technology via a Bluetooth connection.

This object is achieved by a method according to claim 1 and by a system according to claim 8.

With regard to the method, it is provided that the method serves to establish a communication link between an operating unit and a field device from automation engineering, wherein a frame application and a Bluetooth server are executed on the operating unit, wherein the method comprises the following method steps:
connecting the operating unit to a Bluetooth gateway via a radio link by means of the Bluetooth server based on a Bluetooth protocol, wherein the Bluetooth gateway is connected to the field device via a communication network;
establishing and executing a tunnel functionality between the frame application and the Bluetooth gateway;
sending information about the field device from the Bluetooth gateway to the frame application via the radio link, wherein the information contains identification information of the field device and information about a communication protocol used by the communication network; and
instantiating a device driver for the field device and a communication driver with the aid of the information about the field device, wherein the device driver together with the communication driver creates commands and/or queries to the field device in a format which complies with the communication protocol.

According to the invention, the frame application, which is designed in particular according to the FTD/DT standard, opens a tunnel functionality with the underlying field device after connecting to the Bluetooth gateway. With the aid of information that the Bluetooth gateway holds about the field device or queries therefrom, the frame application obtains knowledge regarding the type of field device and the communication protocol of the communication link established between the Bluetooth gateway and the field device. This knowledge is used by the frame application to instantiate a communication driver suitable for the communication protocol of the communication link established between the Bluetooth gateway and the field device and a device driver suitable for the field device.

The operating unit communicates with the underlying Bluetooth gateway via the communication driver by means of the tunnel functionality, wherein this communication path is completely transparent to the user. To communicate with Bluetooth devices, the frame application uses a Bluetooth server, an existing software component. Bluetooth devices can be configured via this Bluetooth server.

The advantage of the method according to the invention is that neither the existing communication drivers nor the existing device drivers for the field devices need to be modified. The method according to the invention requires only minor changes to the frame application in order to allow the use of the tunnel functionality as soon as a Bluetooth gateway with field devices connected to said Bluetooth gateway is available. From the user's perspective, there is no difference from previous communication drivers and device drivers. The communication driver communicates with the Bluetooth gateway because the new tunnel functionality tunnels telegrams within the Bluetooth telegrams in accordance with the communication protocol of the communication link established between the Bluetooth gateway and the field device.

The method according to the invention advantageously uses FDT/DTM technology. Accordingly, the frame application is an FDT frame application. The device driver is a DTM (“device type manager”). The communication driver is a CommDTM.

Field devices that are mentioned in connection with the invention have already been given as examples in the introductory part of the description.

According to one embodiment of the method, the tunnel functionality comprises:
i. embedding the commands and/or queries into first Bluetooth telegrams by means of the Bluetooth server;
ii. transmitting the first Bluetooth telegrams from the Bluetooth server to the Bluetooth gateway via the radio link;
iii. extracting the commands and/or queries from the first Bluetooth telegrams by means of the Bluetooth gateway; and
iv. transferring the extracted commands and/or queries from the Bluetooth gateway to the field device via the communication network.

The Bluetooth server is thus extended by a new communication protocol, the tunnel functionality, with whose help telegrams are tunneled through the existing Bluetooth communication in accordance with the communication protocol of the communication link established between the Bluetooth gateway and the field device. “Tunneling” means that the telegrams are embedded into Bluetooth telegrams without changing the structure or the composition of the telegrams, for example with regard to the preambles and/or the payload portion. Following extraction of the telegrams from the Bluetooth telegram, the telegram is unchanged. In this way, the existing frame application and the modern device drivers and communication drivers can be used to configure field devices connected to the Bluetooth gateway.

A further embodiment of the method provides the following method steps:
generating responses to the commands and/or queries in accordance with the communication protocol by means of the field device, wherein the tunnel functionality further comprises:
   v. embedding the responses into second Bluetooth telegrams by means of the Bluetooth gateway;
   vi. transmitting the second Bluetooth telegrams from the Bluetooth gateway to the Bluetooth server via the radio link;
   vii. extracting the responses from the second Bluetooth telegrams by means of the Bluetooth server; and
   viii. transferring the extracted responses from the Bluetooth server to the device driver.

The method steps regarding the response correspond to those of the command or request path, wherein the Bluetooth server of the frame application and the Bluetooth gateway correspondingly exchange functionalities (embedding and extracting).

According to an advantageous embodiment, the method provides that the information about the field device comprises a network address of the field device in the communication network. The network address is negotiated between the Bluetooth gateway and the field device according to the communication protocol used. The frame application communicates this network address to the communication driver, which addresses the telegrams to this network address. This is advantageous because the communication driver normally has to search the entire range of possible network addresses, but this is now no longer necessary. Experience shows that this step can otherwise take up to about ten minutes on average.

In a development of the method, before the connecting step the Bluetooth server searches for accessible Bluetooth gateways. If accessible Bluetooth gateways are found, the field devices connected to the respective Bluetooth gateways will be listed in the frame application. The operator then selects one of the field devices listed in the list. As a result, the method according to the invention is started, beginning with the step of connecting the Bluetooth server to the corresponding Bluetooth gateway to which the selected field device is connected.

With regard to the system, it is provided that this system is designed to carry out the method and comprises the following components:
an operating unit, wherein a frame application and a Bluetooth server are executed on the operating unit;
a Bluetooth gateway;
a field device, wherein the Bluetooth gateway is connected to the field device via a communication network.

The operating unit is in particular an operating unit within the meaning of the “Field Xpert” marketed by the applicant, or a mobile terminal, for example a tablet or a smartphone.

The Bluetooth gateway is a component having two communications interfaces, one of which sends and receives Bluetooth telegrams and the other of which receives and sends telegrams in accordance with the communication protocol of the communication link established between the Bluetooth gateway and the field device. The Bluetooth gateway further contains an electronic unit for creating Bluetooth telegrams and telegrams in accordance with the communication protocol of the communication link established between the Bluetooth gateway and the field device, embedding into Bluetooth telegrams telegrams received from the field device in accordance with the communication protocol of the communication link established between the Bluetooth gateway and the field device, and from Bluetooth telegrams received from the Bluetooth server extracting telegrams in accordance with the communication protocol of the communication link established between the Bluetooth gateway and the field device.

According to an advantageous embodiment of the system, it is provided that the communication protocol used for communication between the Bluetooth gateway and the field device is a HART protocol or a proprietary communication protocol. In particular, the proprietary protocol is the CDI protocol, which is used by the applicant's field devices.

A further advantageous embodiment of the system provides that the Bluetooth protocol is a Bluetooth LE protocol.

The invention is explained in greater detail with reference to the following FIGURE. Shown is:

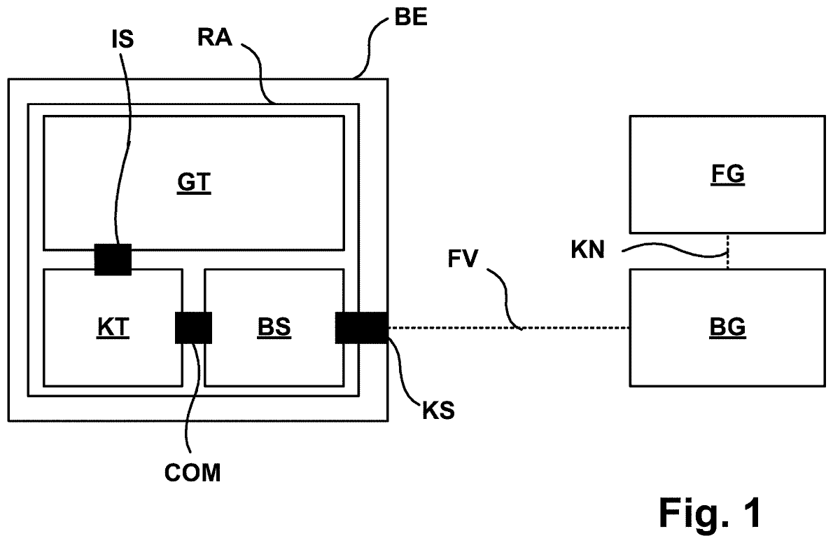

FIG. 1: an exemplary embodiment of the method according to the invention.

The method according to the invention allows the establishment of a communication link between a field device FG and an operating unit BE via a Bluetooth communication link. A frame application RA, in particular an FDT frame application, is executed on the operating unit BE, which is in particular a mobile terminal in the form of a tablet or a smartphone.

The field device FG is connected to a Bluetooth gateway BG via a communication network KN. The communication network KN is designed according to the HART protocol or a proprietary protocol, in particular the CDI (“common data interface”) protocol used by the applicant's field devices. The Bluetooth gateway BG forms the master, and the field device FG forms the slave.

The method begins by starting the frame application RA on the operating unit BE. At the same time, a Bluetooth server BS is started. The Bluetooth server BS creates, sends and receives Bluetooth telegrams via a communications interface KS of the operating unit BE. The Bluetooth server BS can be part of the frame application RA or run as a separate component on the operating unit BE.

The Bluetooth server BS initiates a search for nearby Bluetooth-enabled devices. In the case in which compatible Bluetooth gateways BG are found, the RA frame application provides a device list with all Bluetooth gateways BG found within the Bluetooth range.

If a Bluetooth gateway BG is present and a field device FG is connected thereto, the device list will display the data of the connected field device FG, in particular the device tag, the field device type and/or symbol of the field device FG.

The user selects the field device FG from the device list in the frame application RA, whereupon the Bluetooth server BS starts to connect the Bluetooth gateway BG according to the Bluetooth protocol. After a radio link FV has been established, the Bluetooth server BS checks whether the Bluetooth gateway BG connected via Bluetooth supports the establishment of a tunnel functionality and whether the field device FG is actually connected.

If this is the case, the Bluetooth server BS then opens the tunnel functionality together with the Bluetooth gateway. Information about the connected field devices is sent from the Bluetooth gateway BG to the frame application RA.

According to the information, the frame application RA then instantiates a device driver GT that is suitable for the field device FG and a communication driver KT that is suitable for the protocol of the communication network KN. The device driver GT is in particular a DTM and encapsulates all field device-specific functionalities and commands and allows the creation of commands or requests suitable for the type of field device FG and the processing of the responses of the field device FG. The communication driver KT is in particular a CommDTM and makes possible the conversion of commands or requests into telegrams compliant with the protocol of the communication network KN.

The established tunnel functionality is described below:

The user begins by configuring the underlying field device FG with the aid of the device driver GT. For example, the user selects a parameter value of the field device FG that is to be changed. The device driver GT creates an operating command to the field device FG, and the communication driver creates a corresponding telegram in the format of the protocol of the communication network KN, which contains the operating command. The transfer of the operating command from the device driver GT to the communication driver KT takes place via an internal FDT interface IS of the frame application RA. The communication driver KT transfers the created telegram to a special interface, a virtual COM port. The communication driver KT is designed to transfer the telegram to an actual COM port, which sends the telegram via the actual communication network KN. In the method according to the invention, the virtual COM port simulates an actual COM port, which transfers the telegram to the Bluetooth server. In this way, the system, which consists of a device driver GT and communication driver KT, does not need to be modified.

The Bluetooth server embeds the telegram transferred by the communication driver KT into a first Bluetooth telegram and transmits this first Bluetooth telegram to the Bluetooth gateway BG via the established radio link FV. The Bluetooth gateway BG extracts from the first Bluetooth telegram the telegram containing the operating command and transmits this telegram, which is now in the correct protocol, to the field device FG via the communication network.

The field device FG processes the operating command, sets the new parameter value and creates a response telegram containing a confirmation message.

The field device FG sends the response telegram, which has the format of the communication network protocol KN, to the Bluetooth gateway via the communication network. The Bluetooth gateway BG embeds the response telegram into a second Bluetooth telegram and transmits it to the Bluetooth server BS via the radio link FV.

The Bluetooth server extracts the response telegram from the second Bluetooth telegram and transmits the response telegram to the communication driver via the virtual COM port COM. Said virtual COM port extracts the confirmation message from the response telegram and transmits the confirmation message to the device driver GT via the internal FDT interface IS. The device driver GT processes the confirmation message and ensures that the confirmation message is communicated to the user via the frame application RA, in particular visually.

List of reference signs

| | |
|---|---|
| BE | Operating unit |
| BG | Bluetooth gateway |
| BS | Bluetooth server |
| COM | Virtual COM port |
| FG | Field device |
| FV | Radio link |
| GT | Device driver |
| IS | Internal interface |
| KN | Communication network |
| KS | Communications interface |
| KT | Communication driver |
| RA | Frame application |

1-10. (canceled)

11. A method for establishing a communication link between an operating unit and a field device from automation engineering, wherein a frame application and a Bluetooth server are executed on the operating unit, the method comprising:
connecting the operating unit to a Bluetooth gateway via a radio link and via the Bluetooth server on the basis of a Bluetooth protocol, wherein the Bluetooth gateway is connected to the field device via a communication network;
establishing and executing a tunnel functionality between the frame application and the Bluetooth gateway;
sending information about the field device from the Bluetooth gateway to the frame application via the radio link, wherein the information contains identification information of the field device and information about a communication protocol used by the communication network; and
instantiating a device driver for the field device and a communication driver on the basis of the information about the field device, wherein the device driver together with the communication driver are configured to create commands and/or queries to the field device in a format that complies with the communication protocol.

12. The method according to claim 11, wherein the tunnel functionality comprises:
i. embedding the commands and/or queries into first Bluetooth telegrams via the Bluetooth server;
ii. transmitting the first Bluetooth telegrams from the Bluetooth server to the Bluetooth gateway via the radio link;
iii. extracting the commands and/or queries from the first Bluetooth telegrams via the Bluetooth gateway; and
iv. transferring the extracted commands and/or queries from the Bluetooth gateway to the field device via the communication network.

13. The method according to claim 12, further comprising:
generating, by the field device, responses to the commands and/or queries in accordance with the communication protocol, wherein the tunnel functionality further comprises:
V. embedding the responses in second Bluetooth telegrams via the Bluetooth gateway;
vi. transmitting the second Bluetooth telegrams from the Bluetooth gateway to the Bluetooth server via the radio link;
vii. extracting the responses from the second Bluetooth telegrams via the Bluetooth server; and
viii. transferring the extracted responses from the Bluetooth server to the device driver.

14. The method according to claim 11, wherein the information about the field device includes a network address of the field device in the communication network.

15. The method according to claim 11, further comprising:
before the connecting step, searching by the Bluetooth server for accessible Bluetooth gateways.

16. The method according to claim 15, wherein when accessible Bluetooth gateways are found, field devices connected to the respective Bluetooth gateways are listed in the frame application.

17. The method according to claim 16, wherein one of the field devices listed in the list is selected and the method is then started, beginning with the step of connecting the Bluetooth server to the corresponding Bluetooth gateway to which the selected field device is connected.

18. A system, comprising:
an operating unit, wherein a frame application and a Bluetooth server are executed on the operating unit;
a Bluetooth gateway; and
a field device from automation engineering, wherein the Bluetooth gateway is connected to the field device via a communication network,
wherein the system is configured to establish a communication link between the operating unit and the field device by:
connecting the operating unit to the Bluetooth gateway via a radio link and via the Bluetooth server on the basis of a Bluetooth protocol;
establishing and executing a tunnel functionality between the frame application and the Bluetooth gateway;
sending information about the field device from the Bluetooth gateway to the frame application via the radio link, wherein the information contains identification information of the field device and information about a communication protocol used by the communication network; and
instantiating a device driver for the field device and a communication driver on the basis of the information about the field device, wherein the device driver together with the communication driver are configured to create commands and/or queries to the field device in a format that complies with the communication protocol.

19. The system according to claim 18, wherein the communication protocol is a HART protocol or a proprietary communication protocol.

20. The system according to claim 18, wherein the Bluetooth protocol is a Bluetooth Low Energy (LE) protocol.
